(19) United States
(12) Patent Application Publication
(10) Pub. No.: US 2005/0065956 A1
(43) Pub. Date: Mar. 24, 2005

(54) System of binding all computerized organizational intelligence on a server computer and RDBMS portal software interface tool and methodology

(76) Inventor: Peter Ralph Frederick Brown, Falls Creek (AU)

Correspondence Address: PRF Brown, PO Box 194, Huskisson, NSW, 2540, AU

(21) Appl. No.: 10/624,910

(22) Filed: Jul. 23, 2003

(30) Foreign Application Priority Data
Jul. 11, 2002 (AU) 2002950216

(51) Int. Cl. G06F 17/00

(52) U.S. Cl. 707/102

(57) ABSTRACT

A system of binding organizational intelligence to a server machine EO whereby it is no longer distributed throughout both the client(s) and the server(s) but managed exclusively within the RDBMS. An RDBMS portal software tool possessing analytical and data manipulative functionalities, but by design no organizational intelligence, is installed and configured at an end user computer. A data table and stored procedure are created in the RDBMS. The table serves registry and coordination functions, while the stored procedure functions as a menu procedure. The tool is the common interface for all stored procedures and for the user. The user passes instructions to the tool, and the tool passes instructions to the RDBMS to execute stored procedures. The tool receives back from the RDBMS the data sets which results from their execution and provides them to the user. The user may manipulate the data and perform analyses using the tool.

### RELATED APPLICATION

Australian provisional patent 2002950216 lodged Jul. 11, 2002

### FIELD OF THE INVENTION

The field of the invention is information technology, more specifically information technology management.

### BACKGROUND

Information Technology Management practice today and for at least the last two decades involves managing the dynamics of three separate yet highly interconnected computer software systems environments, shown at FIG. 1:
1) The machine (and network) operating systems software environment (E1)
2) The database management system software environment (E2)
3) The database application system software environment. (E3)

In the first environment (E1) of computer systems software leading upward from the material hardware (E0) and the physical connectivity 101 to other machines are the machine operating systems software and the network operating systems software resident on all client and server computers. Examples of this would include Windows XP, Unix, etc.

Generally once an organization has grown large enough it will require the services of a database management system software for its central information storage and retrieval services.

The second environment of computer system software (E2), in a typical midrange to large organization is some form of database management system (DBMS), or more often, some form of relational database management system (RDBMS). Such RDBMS software is also vendor specific, and examples would include the Oracle RDBMS (Oracle), the IBM RDBMS (DB2) and the Microsoft RDBMS (SQL Server).

In this specialist software environment E2 is stored the organization's database file, and services for operational management of this data, such as backups, indexations, and many other automation features. Here also is resident a common native programming language called SQL, whereby the data may be manipulated within the RDBMS. Database specific programs can be encoded in SQL and stored within the RDBMS in the form of RDBMS stored procedures.

The permutations of these two E1 and E2 computer systems software is remarkably small and it is from this small set of permutations that the typical midrange to large organization selects a foundation upon which to operate the third layer of computer systems software. Once an organization has initially selected and physically acquired an RDBMS software environment, an important event occurs. The organization loads up all its data collection repositories into the RDBMS where it is bound into a physical database file on a server machine.

The organization now needs to acquire an application system software to manipulate this data. That is, software by which their organizational specific data, physically stored within the RDBMS environment may be manipulated, meaning created, maintained, reported, displayed, printed, exported, etc.

In the third environment E3 of computer systems software are the organization specific database application system software. This is the software that the users in an organization utilise to connect to, interface and manipulate the organizational data. Examples of database application system software are diverse due to the diversity of organizational forms—scientific, educational, business, government, etc. and include retail packaged software for managing stock for sale, manufacturing industry packaged software such as SAP, intellectual property management software such as InProma, real estate and property management packages, scientific database applications of all varieties, government database packages for the registration of cars, and land and houses and voters, educational related databases such as that required at universities.

Typically there exists a core application system software environment by which the main activity of the organization is serviced. For example in patent attorney offices the main application system software would be one which is responsible for the management of intellectual properties, related client parties and the related deadlines and formalities. In a manufacturing business the application system software would be responsible for the tracking of component parts, taking orders, moving stock about, shipping stock, etc.

Additionally, typically associated with an organization's main and specialist application system software are one or more general application systems, such as financial modules (eg: accounts receivable, accounts payable and general ledger application systems software). These may be part of the main module, or separate modules integrated to the main module.

As shown in FIG. 1 all these three types of computer systems software run concurrently providing services to the higher level system software. E1 supports E2 and E2 supports E3. This is also the case when the client-server architecture is considered.

As shown in FIG. 2 a server machine E0s is connected to a physical network 201 that could be internal to an organization of external on the internet. Also connected to the physical link is a client machine E0c.

The same computer system software environments E1 to E3 shown in FIG. 1 and now distributed and mapped across a client-server architecture.

On the left hand side is a replica of the schematic of FIG. 1, connected to a second replica of the schematic of FIG. 1 by this physical link 201.

The client operating system software and network operating system software E1c is not necessarily going to be any different that the server operating system software and network operating system software E1s.

There is usually no relational database management system (RDBMS) software on the client E2c machine, because invariably this RDBMS software resides on a dedicated server machine E2s.

Thus the corresponding box on the client machine E2c (left hand side) is intentionally left blank of RDBMS software. However there are certain types of computer software that may be classified as being operative within this environment E2c, by their nature direct clients to the native services available within the RDBMS environment E2s. Examples of such software would include database administration software E2c, by which database administrators (DBA's) directly query and interact with the RDBMS software E2s, such as Microsoft's Query Analyser, or Enterprise Manager.

Bound to the server machine E0s by the operating system software E1s but under direction of the database management system software E2s is the database file itself.

In FIG. 2 at the top boxes E3s and E3c is the database application systems software of the server E3s and the client E3c respectively.

Typically large suites of application system software components are loaded E3c on the client end user machines and used to access and receive database information and perform specific manipulation of data. In recent years there has been an increasing trend to load corresponding components of the database application system within the RDBMS environment such that the application level system software components talk directly to RDBMS components, these RDBMS components often being stored procedures.

Additionally the server components E3s of the application system software are used by the client components E3c of the same application system software.

In a midrange to large organization, dependent upon the development history of the application system software that services its end users, this third systems environment is often also the most extensive of the three environments. It has been developed to reflect the workflow practices of the organization, to permit user manipulation of the organizational specific database in systematic and conventional methods relevant to organizational need at that time.

This third computer systems environment (union of E3s+E3c) is also often correspondingly the most complex, because it represents all the end user interfaces (E3c) required to collect and to display the detailed database information for the organization, stored within the RDBMS layer E2s.

Outlined above are the three separate yet heavily interwoven computer system software environments that are at the heart of practically every large organizational endeavour on the planet.

At the central issue of data processing in today's technology is the interchange of data between the two systems software environment depicted in FIG. 2 as Es2 and E3c. These two boxes essentially contain the user interface, all the program code of the database system and the application system, and the database file itself.

The following FIG. 3 considers the more detailed inter-relationships between these two above mentioned specific environments of computer systems software within the overall environment provided earlier.

The lower box 301 represents the server RDBMS software environment whereas the top box 303 represents the client database application system software environment.

There exists constant flows of data between the end user database application system software 303 and the server RDBMS software (301) by means of the physical link 302, and the software services provided by the operating and network operating systems shown earlier in FIG. 2.

The storage and use of contemporary end user database application system software 303 on the client machine is usually in the form of a suite of component objects 304, which can be represent by the series A_{—}1, A_{—}2, A_{—}3, . . . A_n, where n is an integer. Essentially this represents an extendible series of components 1 to n.

These program objects, or executables are fashioned out of a host of different program development languages and tools. Together, they may be assembled in modules, to agglomerate to a commercial database application system software suite called Product “A” (constituent of component objects A_{—}1, A_{—}2, A_{—}3, . . . A_n)

An organization may in fact run multiple database application system software packages. They may all be entirely different from one another, or have common domains of activity. This situation can be generalized to the first example such that instead of there being only Package A, there are indeed Packages A, B and C etc.

The use of the series 304 above is not to limit the number of packages being considered, it is to serve as the general example, independent of scale.

As shown in FIG. 3 at 301 is server RDBMS environment. At 305 there is a distinct database file named database A contained and bound within the RDBMS 301.

Within database A 305 are two further sub environments. The first are the database tables 306 associated with database A 305, and the second are the database stored procedures 307 associated with the database A 305. These and other database objects associated with the database A are physically stored on the server by the database management system software 301 in a physical database file 305.

The invention is concerned only with RDBMS or DBMS Software 301 in which the database stored procedures 307 are physically existent and separated from the database tables 306, and more significantly, physically separately addressable by other objects in the system environment, such as for example any of the components A_n of 304.

This specific distinction immediately precludes a number of contemporary database management system products within which there exists no such entities equivalent to DBMS stored procedures. The three large RDBMS vendors do have addressable stored procedures. Examples of relational database management system software that do have such existent and distinct entities known as stored procedures, include SQL Server, Oracle and DB2.

Let me additionally make the point that the objects within the database application software environment such as Product A need not be of the form A_n.exe in a literal fashion.

Although the above outline is of a theoretical and static arrangement of operation and while the resultant computer systems environment may appear complex, is it quite simple when compared to the results of introducing the element of real-time change to the aforementioned three systems environments E1, E2 and E3

Information technology change management is essentially the coordination of change within these three separate computer system environments.

From a systems perspective it would be far easier to deal with the integration of two computer systems environments than having to deal with the dynamic integration of three.

Dramatic simplification of information technology management would result if the third systems environment E3 (the application system software environment) could be uprooted from the client environment E3c, and migrated into the RDBMS environment E2s. Reducing the number of independent computer systems environments to be managed, but more expressly, change managed, from the original three environments to only two environments would be an interesting challenge.

If such a migration mechanism could be developed, then the complete set of organizational intelligence contained in an organization's database and in an organization's application system software code could for the first time be physically united and bound together in completeness.

### SUMMARY

A system of binding organizational intelligence to a server machine whereby it is no longer distributed throughout both the client(s) and the server(s) but managed exclusively within the RDBMS. An RDBMS portal software tool possessing analytical and data manipulative functionalities, but by design no organizational intelligence, is installed and configured at an end user computer. A data table and stored procedure are created in the RDBMS. The table serves registry and coordination functions, while the stored procedure functions as a menu procedure. The tool is the common interface for all stored procedures and for the user. The user passes instructions to the tool, and the tool passes instructions to the RDBMS to execute stored procedures. The tool receives back from the RDBMS the data sets which results from their execution and provides them to the user. The user may manipulate the data and perform analyses using the tool.

### BRIEF DESCRIPTION OF THE DIAGRAMMATIC FIGURES

FIG. 1 is a conceptual overview of the modern computer systems environment showing the three operational environments of computer systems software.

FIG. 2 is an expansion of the view presented in FIG. 1, but with recognition that a physical network may connect two or more computer systems, and that in general the database server machine is separate from the user's machine.

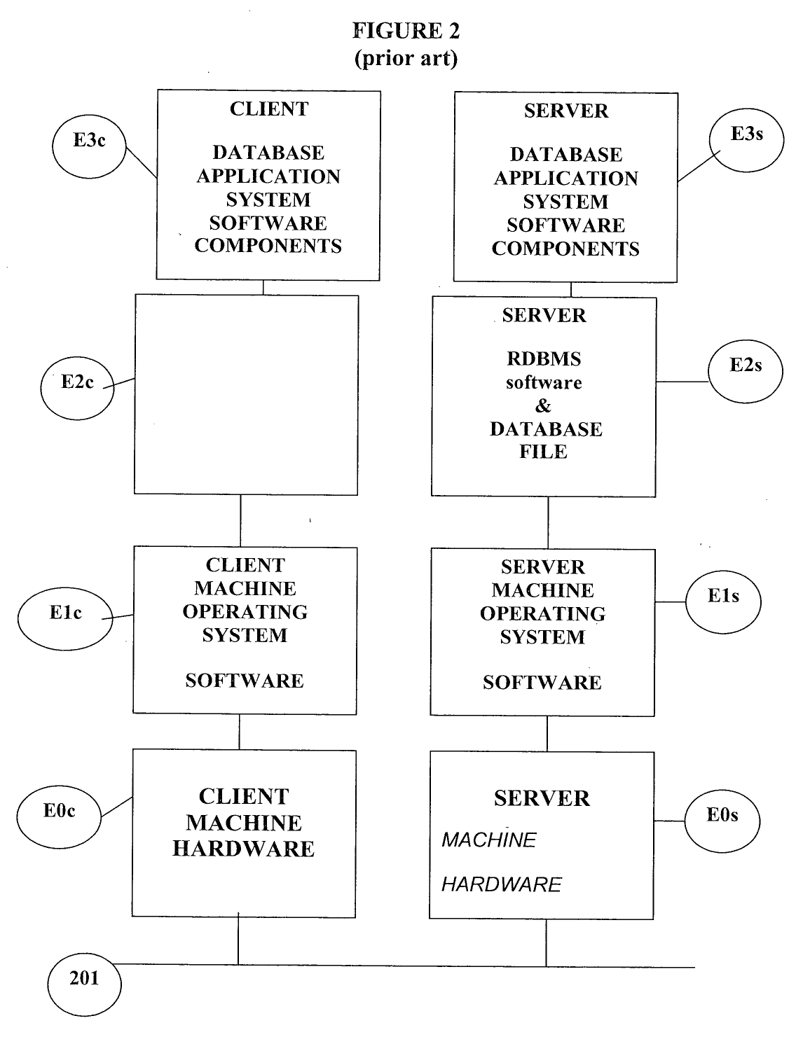

FIG. 3 is a slice out of FIG. 2 showing the client application systems software environment and the server relational database management system (RDBMS) environment. Detail is presented within these two environments.

FIG. 4 presents the same schematic as FIG. 2 but shows where the RDBMS Interface Tool software is classified in such an arrangement. It should be noted that the two boxes at the top are empty.

FIG. 5 is a slice out of FIG. 4 showing only the client database application system software environment, and the server environment, with more detail.

FIG. 6 is listing of steps required to install the tool in an established environment, and to configure both it and the RDBMS for use.

FIG. 7 outlines the steps required to create and deploy to an end user some form of very complex query, analysis and reporting application system.

FIG. 8 shows the process by which the end user receives the initial database application system software menu.

FIG. 9 shows the process by which the end user requests execution and receives the output of application system software components based on the server.

### DETAILED DESCRIPTION

This section relates to the theoretical and practical considerations of what I will term organizational intelligence (OI). It should be clearly noted this consideration is to be applied and restricted to the computer system environment outlined earlier section.

In terms of the computer systems that support the management, administration and operation of organizations on a day-to-day basis, we need to ask the question, what is organizational intelligence?

A short and succinct answer is that OI is at least the sum total of the organizational data and additionally at least the sum of the source code for all database application system software in use by this organization.

There are likely other terms to be included in a more general treatment, but the above should serve here. We could represent this by:
OI (Total)>=OI (Invested in database)+OI (program code of application system)

This above definition is general and a more formal definition follows.

By example, in an organization running SQL Server RDBMS may be a law firm having a database application system for practice management and another for their financials. I would define the organization intelligence within this computer system to be:
OI (Total)=OI of the organization's database+OI of the source code defined in the application system
Theoretical Section
Hypothesis 1:

The quantum of organizational intelligence bound in a computer system is at least the sum of, the sum of the quantum of organizational intelligence bound within each of the different computer systems software environments populated by said computer system.

An example of “binding” is that the library database file (above example) is a physical file, perhaps called “library.dat” which is bound by the SQL Server RDBMS software into a single database file. It is a complete and unified process. Likewise, software when applied to a database file is where the

Using this hypothesis, we can formulate a theorem of location and distribution of organizational intelligence within a computer system without having to formally define exactly what organizational intelligence is.
Theorem of location and distribution of Organizational Intelligence

$$\begin{matrix}Computer \\ System \\ Software\end{matrix} {\int }_{E1}^{En} ( OI ) \geq E1 {\int }_{1}^{n} ( OI ) + E2 {\int }_{1}^{n} ( OI ) + E3 {\int }_{1}^{n} ( \text{?} \\ \text{?} \text{indicates text missing or illegible when filed}$$

In words, this can be expressed by the following. The sum dynamic total of organizational intelligence bound within an organization's computer systems is at least equal to the sum of the sum dynamic total of organizational intelligence bound with each of the operational computer systems software environments.

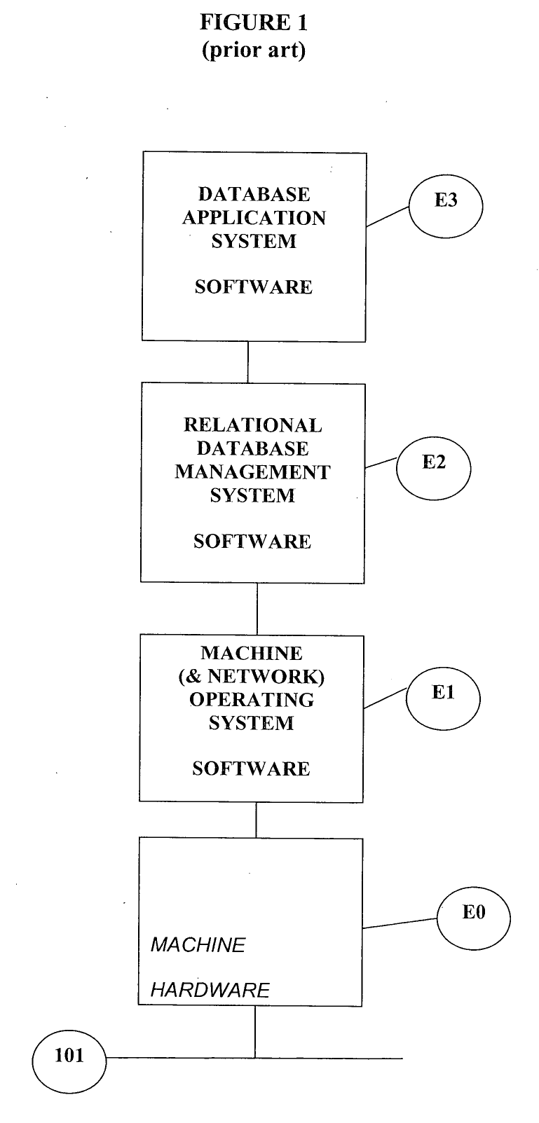

At FIG. 1 these environments have been identified as E1, E2 and E3

The above first term of E1 represents the dynamic total of all OI bound within all components 1 to n of the operating system, and network operating system software as shown in box E1 of FIG. 1.

The above second term of E2 represents the dynamic total of all OI bound within all components 1 to n of the database management system software as shown in box E2 of FIG. 1.

The above third term of E3 represents the dynamic total of all OI bound within all components 1 to n of the database application system software as shown in box E3 of FIG. 1.

Client Server Considerations

When we expand the above consideration to a computer system having client-server architecture then the number of terms also needs to be expanded. However, there is a simplification which can be made to the above theorem for all practical purposes in that the first component of the expression is invariable very small when compared to the other terms. This notion requires some further detailed consideration of the nature of the component objects in each of the three environments considered.

Essentially we may simplify the above expression by observing that there are differences in the software types E1, E2 and E3. E1 is the operating system software, and contains very little organisation specific intelligence. It it tightly coordinated with the higher environments of software E2 and E3, but both E2 and E3 contain a vast proportion of the data component and the software code propertion of OI.

Because of this, the first term in the above general expression Theorem of Location of OI can be disregarded. The remaining two terms then are expended to include the separate contributions of the server and the contributions of the client.

The resultant expression is as follows:
OI>=SUM of OI (bound on the server by RDBMS software) {E2s}[includes the organization's specific database file]+SUM of OI (on server by application system software code) {E3s}+SUM of OI (on client within application system software code) {E3c}
or, if the coding is consistently applied to the drawings and descriptions:
OI (total)=OI (in E2s)+OI (in E3s)++OI (in E3c)

This depicts the prior art information technology management solution for the storage or binding or development of organizational intelligence.

Organizational intelligence is today stored in the union and conjunction of the above two interrelated computer software systems environments—the RDBMS software environment and the application software environment.

This represents a redundancy of record keeping, administration and management. Because this OI is distributed over the entire architecture (client and server) of the computer system and not all in the one place, it cannot easily be discerned or developed.

It would be a far better and simpler operational solution to try and contain its distribution to as few environments of computer system software as possible.

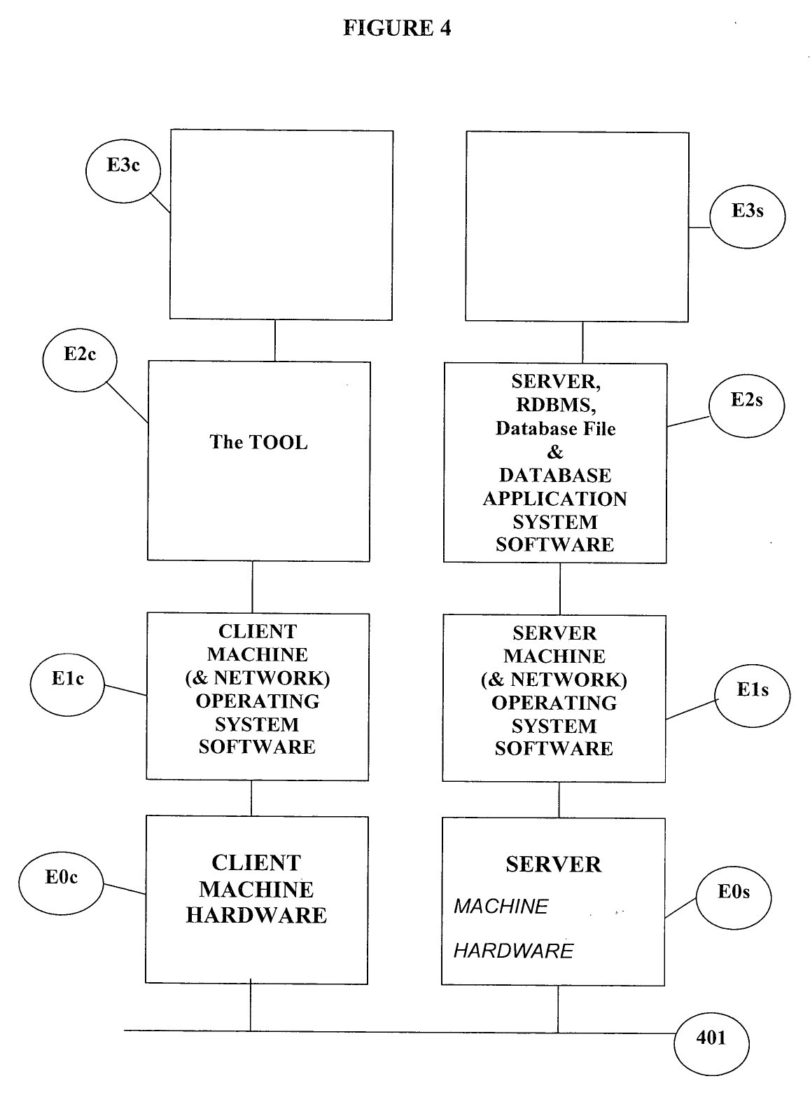

At FIG. 4, we note that there is no change to the following series of computer system environments: 401 physical link, 402 server and 412 client machines, 403 and 413 are also unchanged.

At FIG. 4 in the box E3c reserved for the contents of the client database application systems software environment there is an empty set. There are no longer any client application systems software components resident on the client machine at E3c.

At FIG. 4 in the box E3s reserved for the contents of the server database application systems software environment there is an empty set. There are no longer any server application systems software components resident on the client machine at E3s.

Where did all the components E3c and E3s go? At FIG. 4 in the box E2s reserved for the contents of the server RDBMS software environment we have an additional item called database application software system. This is inside the RDBMS, with the data file. This is where we have bound the application system components, as RDBMS stored procedures, every last one in SQL, except one component to the suite.

At FIG. 4, in the box labelled E2C we see the tool revealed.

It is a very small executable program which makes a direct connection to the RDBMS and functions primarily as the user interface to the suite of stored procedures. The user sends instructions via the tool to the RDBMS software to execute a component stored procedure. The RDBMS executes the stored procedure and sends the resultant data output back to the tool, in its role as an interface and the tool provides the data to the end user.

Normally, many of the components in an application system suite have their own user interfaces, but using the methodology disclosed herein we create one stored procedure to service as the menu procedure for all the other stored procedure components to the application system. We create a table within the RDBMS to serve as a registry and a means to coordinate the suite.

It dwells with the environment E2c because it connects directly to the RDBMS environment much like the DBA tools discussed earlier in relation to E2c. It has no peers in this environment, and it runs in isolation as a portal between the end organizational user and the RDBMS.

It role in things is to send instructions to the RDBMS to execute stored procedures and to receive the data output of this execution. Thus the interface is also a generic service of data in a two way flow. While it possesses analytical and data manipulation capabilities (including data maintenance) it only acts on data sets provided by the RDBMS. By the characteristics of its service, it possesses little organizational intelligence. It is merely a RDBMS portal software tool.

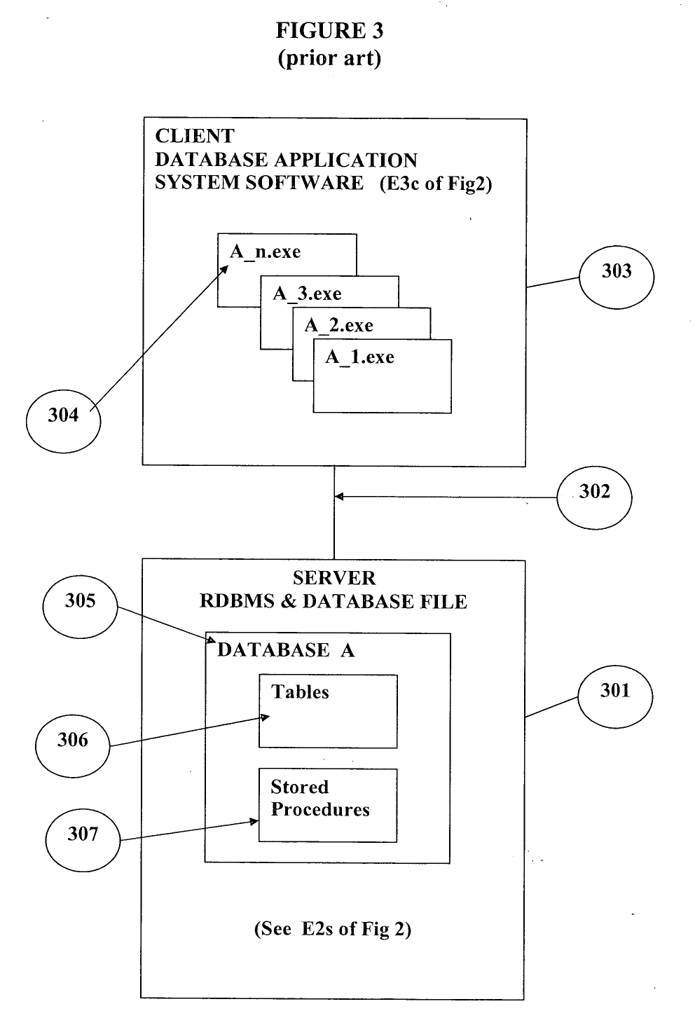

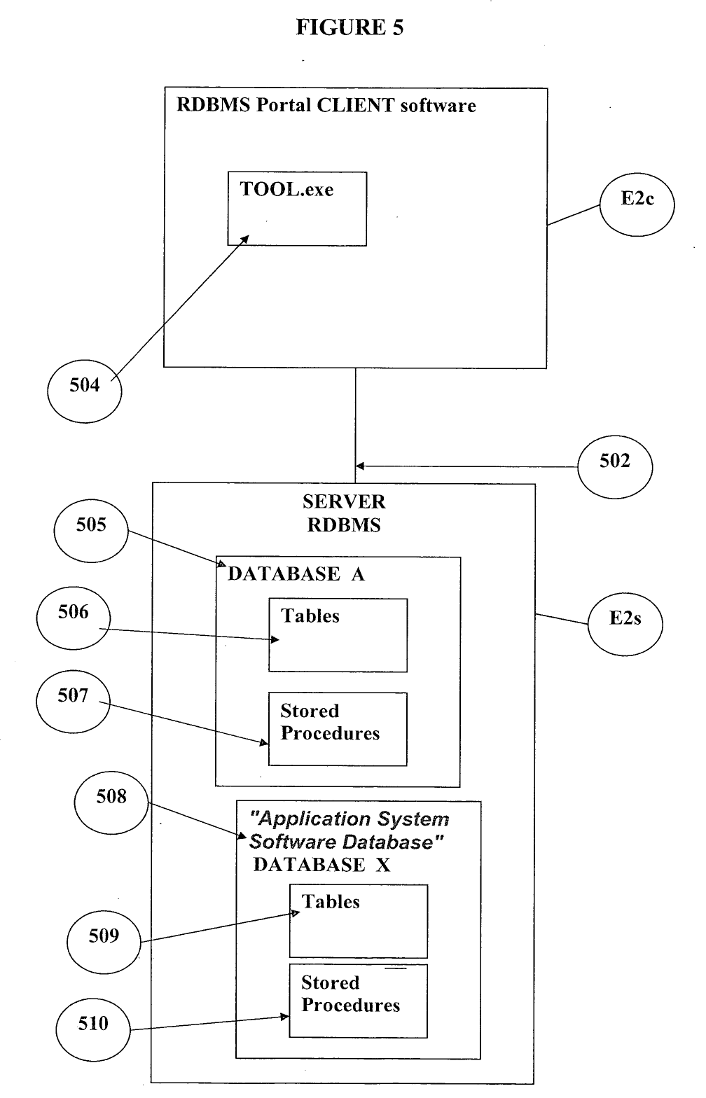

At FIG. 5 attention is focussed to two environments. E2s is the server with the database A 505, containing or binding database tables 506 and stored procedures 507 within its software as was the case earlier presented in FIG. 3.

But in addition to the state prior at FIG. 3, FIG. 5 shows another database X 508 within which there are tables 509 and stored procedures 510. This database X is a database containing all the component objects of any application system suite, as stored procures.

Note that the database X need not have been made separate from A, and that we could have created the additional tables within the database A and the additional stored procedure program objects within the database A. I have used a separate X to highlight the difference between the current client-server technology in the methodology herein disclosed.

In FIG. 5 in box E2c we see again that apart from the contents on the box E2s previously described, there is only the RDBMS portal software tool component external to the RDBMS. It is a service layer in the new system only, a generalised interface tool that sorts and filters and prints and exports data provided to it by the RDBMS. The programmers of the new system are the SQL authors of the stored procedures being executed by the RDBMS. Once created, these must be intelligently registered and classified in the registry table, but that is all that needs doing.

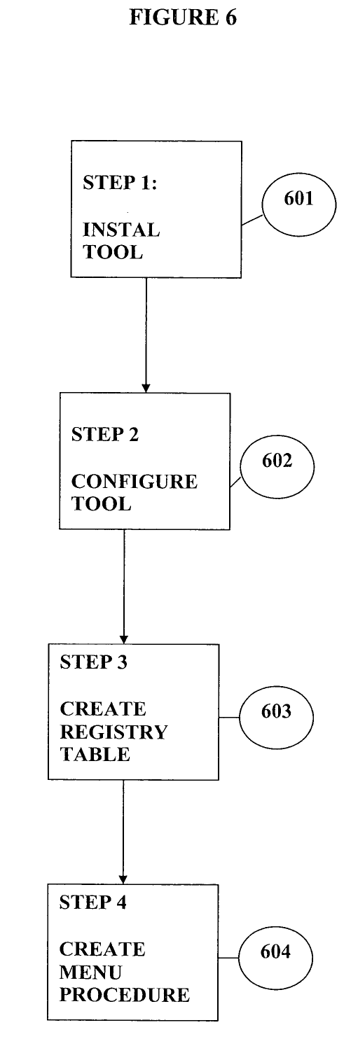

At FIG. 6 we see that step one 601 in operating the system and tool is to instal the tool on an end client computer. The tool will work just as well from the server if required.

At Step 2 602 the tool is configured for use.

At Step 3 603 a table is created in the RDBMS for the registration of all stored procedures which are to be part of this suite of components. The structure of the table is essentially a task ID, a level ID, a stored procedure name and a description of the component as will be displayed to the end user.

At step 4 604 a menu stored procedure is created which will be launched when the tool starts. This menu procedure is passed the user ID, and passes this to the RDBMS. The menu procedure examines the registry and according to the user ID selects all or some of these components for that user.

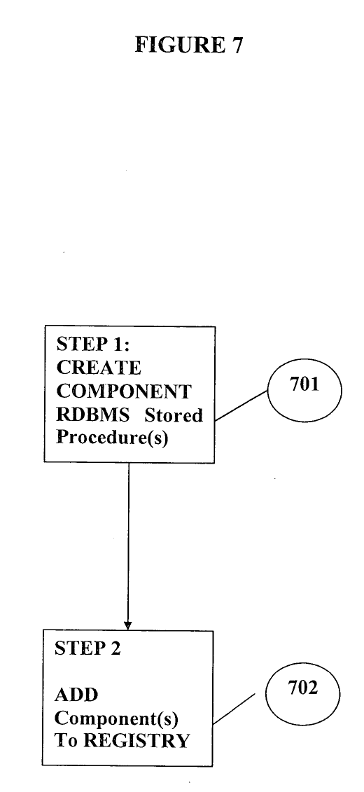

At FIG. 7 is shown the entire process whereby one component application can be developed and deployed to the end user. The first step 701 is to create a stored procedure in the RDBMS. Typically a database administrator knowing SQL, or a SQL skilled person uses the native SQL code within the RDBMS to create a program in that environment which is stored by its name, in its database.

At Step 2 702, a row is added to the registry table representing the addition of the physical stored procedure at step 1. As soon as this registration completes, the new component application created at 701 is available to the end user.

By a method of allocation of menus for workgroups within the organisation, or specialized menus when required with data relevant to its operation. Data supplied here includes the name of the database, registry table, etc.

One stored procedure and one row in the registry table will see an application deployed. To see a hundred applications deployed in this fashion a script can be written. Now that organizational intelligence can be studied in isolation within one supportive RDBMS environment, technology can move ahead to the next phase in its migration out of the hardware layers.

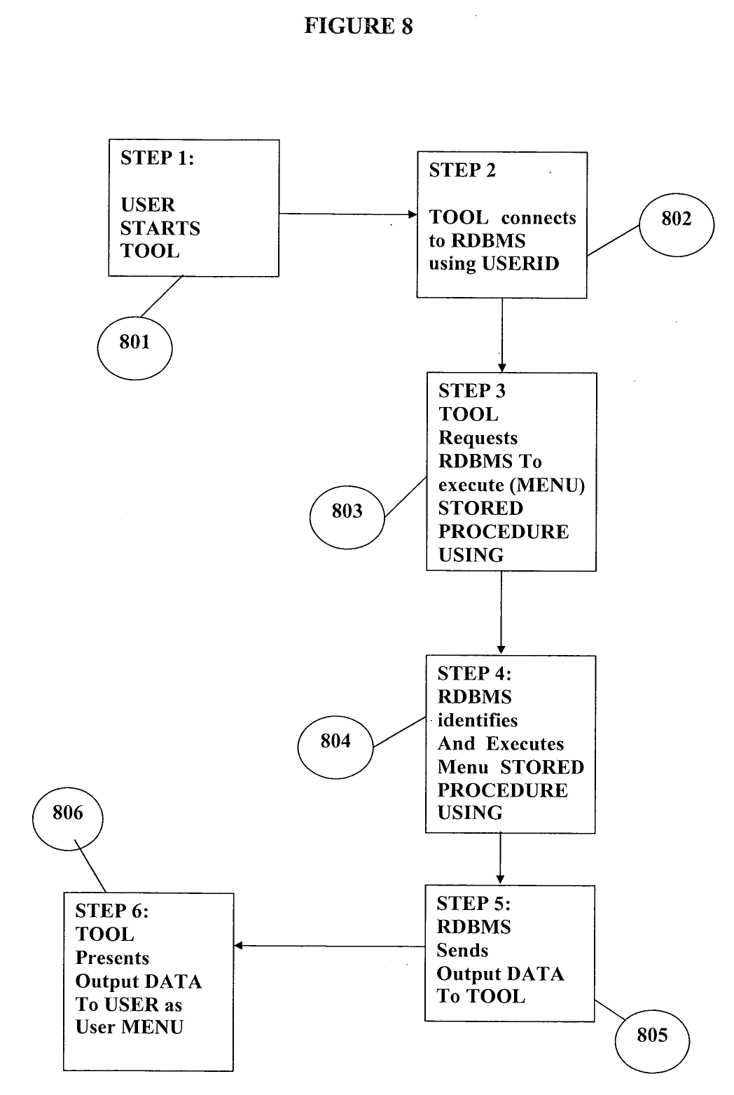

At FIG. 8 is a description of how the tool works at start up.

At step 1 801 the user starts the tool. At step 2 802 the tool connects to the RDBMS passing the user's account ID. At step 3 803 the tool requests the RDBMS to execute the menu stored procedure using the user account ID. At step 4 804 the RDBMS identifies the appropriate stored procedure via the registry and info passed by the tool, and executes it. At step 5 805 the RDBMS send the output data from the execution of the stored procedure to the tool. And finally at step 6 806 the tool presents this same output data to the user as a menu of options.

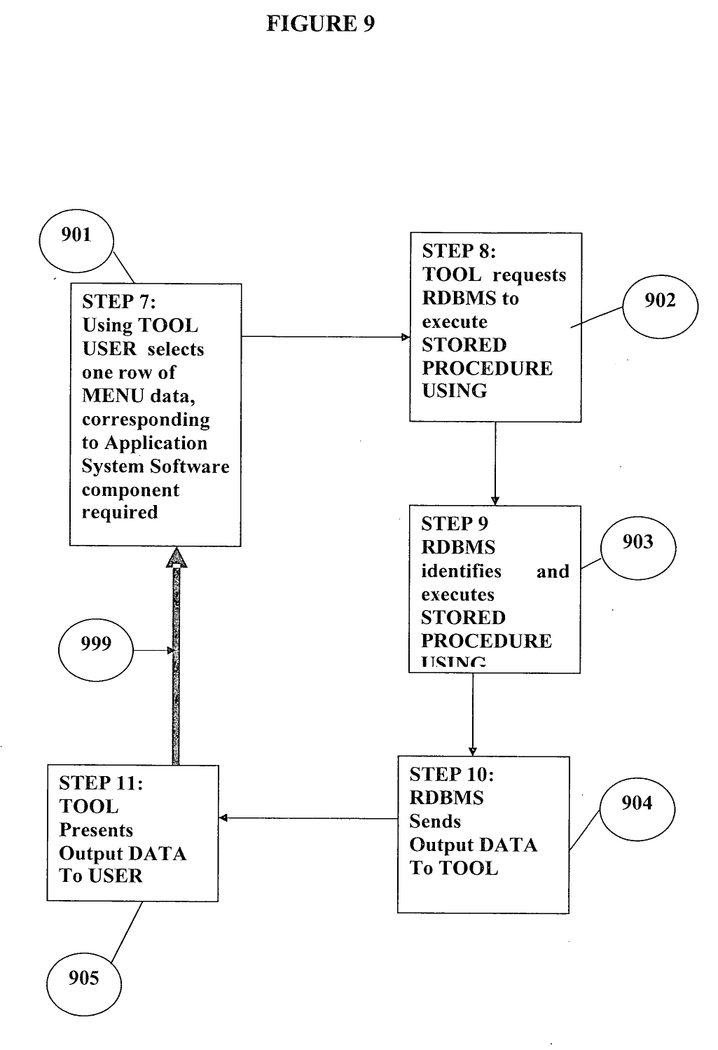

At FIG. 9 is a description of how the tool works after getting the menu data, and thus continues the steps from step 6 in FIG. 8.

At step 7 901 the user through use of the tool selects one row of the menu data corresponding to the application system component required by the user. At step 8 902 the tool requests the RDBMS to execute a stored procedure using the data already present in the menu data set (returned at step 6 at 806 in FIG. 6). At step 9 903 the RDBMS identifies the appropriate stored procedure via the registry and info passed by the tool, and executes it. At step 10 904 the RDBMS send the output data from the execution of the stored procedure to the tool. At step 11 905 the tool presents this same output data to the user as application system data according to the design of the stored procedure executed which gave rise to it.

There is a large thick arrow 999 connecting the box 905 (Step 11) and the box 901 (Step 7) has a special significance. The significance of this line is that from the data presented by the tool at Step 11 (905) the user can again select a row, in the same manner as outlined at step 7. This will invoke another stored procedure associated with this component application system object.

The implication of this is that the first stored procedure presents a summary level data with rows which when selected provide a second level stored procedure with the trigger information to run a subsequent stored procedure to get the detail corresponding to that summary row, and so on, to n levels of drilling into information.

Components can be chained together in this manner: summary level, intermediate detail, detail level, historical detail level, etc. Such an application would require the creation of 5 stored procedures the 1^{st} calling the second, the second the third and so forth. It would also require the registration of these five stored procedures in the registry table.

But after these actions are completed, as described in FIG. 7, the application is available for use by an end user. Note that these actions of development are all within the RDBMS environment.

The tool never requires changing. All change is internalized within the RDBMS.

To summarise we recall . . .
OI (total)=OI (in E2s)+OI (in E3s)++OI (in E3c)

Depicts the prior art information technology management solution for the storage or binding or development of organizational intelligence.

The disclosed system is profoundly simpler,

Everything united within one software environment.

E3s and E3c are now blank boxes, hence the above simplifies to:
OI (total)=OI (bound on the server by RDBMS software) {E2s}
[this includes the organization's specific database file, and is also inclusive of the organization's specific database application system sofiware]

When the organisation does a database backup, the entire set of data and the entire set of program components for the associated application system software, being stored procedures within the RDBMS, get backed up along with the data.

Application systems software can then be delivered in a database. The creation of entire and complete application software system suites can thus be scripted.

1. A system of binding organizational intelligence on a server computer, said system comprising:
at least one server computer having at least one relational database management system (RDBMS) software binding at least one said RDBMS data file to said server and at least one database application system software suite associated with said at least one data file and said server,
also bound within said at least one data file on said at least one server.

2 A software tool comprising
at least one computer connected to RDBMS software having a RDBMS portal software tool said tool an interface between said at least one system as described in claim 1 and at least one end user of said organization.
by which said end user sends instructions to the RDBMS software to execute at least one component of said at least one suite of database application system software on said server computer, and whereby output data arising as a result of said execution is returned to said interface software by the RDBMS software and provided to said end user.

3. A method of binding organizational intelligence on a server computer, said method comprising:
at least one server computer having at least one relational database management system (RDBMS) software binding at least one said RDBMS data file to said server and at least one database application system software suite associated with said at least one data file and said server, also bound within said at least one data file on said at least one server.

4 A software tool according to claim 2 wherein the tool is installed to at least one remote device, communicating with the RDBMS through a communications link which is not a physical link, but an electronic link such as radio, microwaves or other EMR.

5. The method of claim 3, whereby application system software development using stored procedures is comprised of the following steps:
install the software tool on the computer allocated for use to an end user in an organisation, said computer being connected via a network and said user's network access account to a relational database management system (RDBMS)
create one data table within a database within the RDBMS
create one stored procedure within said database within said RDBMS to function as a menu procedure
configure said tool with RDBMS type, connection type, network type, name of said database, name of said menu stored procedure, name of said registry table
development process comprising:
an information request is received by an organisation that resolves to the creation of a new component of application system software
one stored procedure is created within the RDBMS one row of data is added to said registry table
an end usage process comprising:
end user starts using tool
tool reads configuration settings supplied, and end user's user account information from operating system of said user's computer
tool establishes connection to RDBMS under end user account
tool passes a request to RDBMS to for the RDBMS to execute the menu procedure of said name in said database using said security account.
DBMS executes said menu procedure using userid
menu procedure reads all rows from registry table and selects rows for inclusion in output data set
menu procedure returns output data set to RDBMS
DBMS passes data set via the connection back to the tool
tool displays said data, in rows and columns to said end user
end user recognises newly deployed application system software component by its name on one of the said rows
end user double clicks said one row using tool
tool identifies the value contained in the first column of said one row
tool passes a request to the RDBMS to read said registry table using said value as key to the table and to determine the corresponding stored procedure name
DBMS locates item in registry and determines name of stored procedure
DBMS executes said stored procedure by name
Stored procedure executes and returns data set to RDBMS
DBMS passes data set back to the tool
tool displays said data, in rows and columns to said end user

6 The method of claim 3 and 5, where a complex application system component is required, and unable to be satisfied in one stored procedure, the use of more than one level of stored procedures, including the steps of:
identifying core functionalities required by a RDBMS application software system;
creating RDBMS stored procedures as core objects which implement said core functionalities;
creating an RDBMS data table to register and manage said stored procedures;
creating an RDBMS stored procedure to serve as an end user menu procedure;
a RDBMS portal software tool as described in claim 2 is used by the end user as an interface, including the steps of:
tool presents menu to end user user selects core object component via menu tool passes request to RDBMS to execute a core object, RDBMS submits core object for execution core object executes creating a data set as output core object passes output data to RDBMS RDBMS passes said data to tool the tool presents data to user and provides analytical functionality;
whereby separating all said core application functionality and the end user interface into said stored procedures and said tool, respectively, enables said core functionality to exist exclusively within the RDBMS environment.

6. The method of claim 1, wherein an information request is received by an organisation that resolves to the creation of a new component of application software which cannot be resolved trivially by the creation of one stored procedure, a revised development process comprising:
two or more stored procedure are created within the RDBMS
two or more row of data are added to said registry table an end usage process comprising:
end user starts using tool
tool reads configuration settings supplied, and end user's user account information from operating system of said user's computer
tool establishes connection to RDBMS under end user account
tool passes a request to RDBMS to for the RDBMS to execute the menu procedure of said name in said database using said security account.
DBMS executes said menu procedure using userid
menu procedure reads all rows from registry table and selects rows for inclusion in output data set
menu procedure returns output data set to RDBMS
DBMS passes data set via the connection back to the tool
tool displays data, in rows and columns to said end user as summary level data
end user browses rows of said summary data using tool
end selects one summary row for which the detail information is required
end user double clicks said row using tool
the tool identifies the value contained in the first column of said one row
the tool passes a request to the RDBMS to read said registry table using said value as key to the table and to determine the corresponding second level stored procedure name
DBMS locates item in registry and determines name of stored procedure
DBMS executes said second level stored procedure by name
stored procedure executes and returns data set to RDBMS
DBMS passes data set back to the fool
tool displays said detail data, in rows and columns to said end user

7 A tool according to claim 2, used for RDBMS application system software development in accordance with methods outlined in claim 5 or in claim 6

8 The method of claim 3, wherein the schema of registry table is consistent of information similar to the following:
taskid—a specific integer,
levelid—the value 0,
procid—the name by which the RDBMS knows the stored procedure,
description—a textual name by which the end user knows the application
catid—a category code to be associated with the new stored procedure,
enabled—a bit field is set to the value of 1 for deployment,
mode—a varchar field value

9 A software tool according to claim 2, wherein the tool permits the end user to manipulate and analyse said data set by a series of conventional functionality comprising:
end user can toggle the sort order of the entire dataset according the values located on one column of the data set between ascending and descending sort order by clicking the tool in the heading corresponding to said column, multiple sort orders can be imposed by the user on the data by successively repeating this process on different columns
end user can filter the data set by clicking one cell and then clicking the filter control whereby the tool displays only those rows of said data where the value of the column in said rows match the value contained in the column of said cell
end user can adjust the column width used by the tool in presentation of the data set or reduce it to zero by the tool by dragging the header row column boundaries together or apart
end user with or without any manipulation can preview a print before printing said data set to a printer by selecting the print button
end user can at any time export said data set to nominated formats (eg: word table, excel spreadsheet, XML, etc) by selecting the appropriate export function
